(19) United States
(12) Patent Application Publication
(10) Pub. No.: US 2012/0306365 A1
(43) Pub. Date: Dec. 6, 2012

(54) POLYCRYSTALLINE TRANSLUSCENT ALUMINA FOR HIGH INTENSITY DISCHARGE LAMPS

(75) Inventors: Fangming Du, Northfield, OH (US); Thomas J. Boyle, Lyndhurst, OH (US); Shuyi Qin, Shanghai (CN); Zoltan Dobe, Budapest (HU)

(73) Assignee: General Electric Company

(21) Appl. No.: 13/153,676

(22) Filed: Jun. 6, 2011

(51) Int. Cl. H01J 61/30; H01J 9/26; C04B 35/10; H01J 61/20

(52) U.S. Cl. 313/636; 445/26; 501/135

(57) ABSTRACT

A polycrystalline body comprising a MgO/ZrO2-doped aluminum oxide in which alumina grains have an average size of at least 20 μm and wherein the magnesium oxide is present in an amount of at least 250 ppm and the zirconium oxide is present in an amount of at least about 20 ppm of the weight of the ceramic body, and the magnesium and zirconium oxides are present at a molar ratio of about 1:2 to about 15:1.

### BACKGROUND OF THE INVENTION

The present invention relates generally to polycrystalline alumina ceramics. It finds particular application in connection with a ceramic composition which includes magnesia and zirconia, and which is suited to formation of a discharge vessel for a high intensity discharge lamp, for example a high pressure sodium lamp, and will be described with particular reference thereto.

Discharge tubes for high intensity discharge (HID) lamps, and in particular, high pressure sodium (HPS) lamps have been fabricated from a variety of translucent alumina materials, including polycrystalline alumina and single crystalline alumina (sapphire). The discharge tube made from these materials further includes a fill of light-emitting elements, such as sodium and mercury, and a starting gas, such as argon. When the lamp is energized, an arc discharge forms with a characteristic emission spectrum which is related to the particular composition of the fill.

The life of such sodium lamps is frequently limited by the loss of the sodium portion of the fill during lamp operation by diffusion of sodium ions through the wall of the discharge tube. The lost sodium is then unavailable to the arc discharge and can no longer contribute its characteristic emissions, causing the light output to gradually diminish, and causing the color of the light emitted to shift from white towards blue. In addition, the arc becomes more constricted, and in a horizontally operated lamp, the arc may bow against and soften the arc chamber wall. Sodium loss may also cause the operating voltage of the lamp to increase to the point where the arc can no longer be sustained by the ballast and failure of the lamp may result.

It is well known that by adding magnesium oxide to the alumina ceramic used to create the discharge tube, a high degree of translucency may be obtained. This is the result of the elimination of alumina porosity and control of the alumina grain growth. However, too much magnesium oxide is undesirable due to the fact that the magnesium oxide further interacts with the alumina of the arc chamber to form a second phase, a spinel magnesium aluminum oxide phase, at the alumina grain boundaries. This spinel phase leads to lower light transmission. More critically, this phase provides areas of the chamber that are more vulnerable to sodium attack during lamp burning, resulting in significantly increased sodium leakage and leading to lower lumen output and shorter lamp life.

In addition to the foregoing problems caused by sodium depletion, lamps made from ceramics doped with magnesium oxide have been shown to be susceptible to darkening of the outer jacket when the lamps are operated at wattages above the design space of the ceramic arc tube. Darkening of the glass outer jacket has been linked to a combination of evaporation of the ceramic arc chamber and sodium loss through the walls of the arc tube due to reaction and diffusion mechanisms, including through the spinel magnesium aluminum oxide phase as discussed above. The sodium that migrates through the arc chamber wall deposits on the inside wall of the evacuated outer lamp envelope causing a brownish stain on the envelope which, in turn, further reduces the light output of the lamp, i.e. limits lumen output, and reduces the useful life of the lamp.

Still further, in addition to problems relating to or caused by sodium diffusion, such as wall darkening, the sodium in the arc can react with the alumina at the grain boundaries to form sodium aluminate, which adversely affects the structural integrity of the tube and shortens lamp life.

More recently, discharge lamps are being designed for ever increasing internal sodium partial pressure within the alumina arc tube predominantly to improve the color rendition and provide a whiter emitted light. However, the higher internal sodium pressure causes a correlative increase in the rate of sodium loss from the arc chamber, compounding the problems noted above. As has been stated, progressive sodium loss results in a corresponding continual rise in the lamp operating voltage, a decrease of both correlated color temperature and color rendering index, realized in a color shift from white to pink, wall darkening, and other limitations to useful lamp life.

The manufacture of polycrystalline alumina (PCA) and single crystal alumina (sapphire) HPS arc discharge lamps is known. U.S. Pat. Nos. 3,026,210, 4,150,317 and 4,285,732, to Coble, Alaska et al., and Charles et al., respectively, disclose the production of a high density alumina body having improved visible light transmission using relatively pure alumina powder and including small amounts of magnesia in the two former patents, and a mixture of zirconium and hafnium oxides in the latter. Nonetheless, there remains a need to provide a more ideal alumina ceramic for lamp chamber usage wherein the sintered alumina contains only that amount of magnesium oxide necessary to the successful elimination of pores and to obtaining enough ceramic density, transmission, and homogeneous grain size distribution to optimize lamp performance, while minimizing sodium depletion and its associated problems, i.e. increased operating voltage, reduced lumen output, wall darkening, and shorter lamp life. It is further desirable to provide a suitable alumina ceramic for use in lamps that allows for high efficiency and reduced power consumption.

Therefore, a need exists for an alumina arc tube having a reduced tendency to permit sodium diffusion, thus avoiding the foregoing problems, and which also provides high transmission of light. This invention discloses a sintered alumina composition containing only the minimal amount of magnesium oxide, in conjunction with a specified amount of zirconium oxide, necessary to control alumina grain growth and effectively remove pores, and yet avoid sodium leakage problems.

### BRIEF DESCRIPTION OF THE INVENTION

In one aspect of the exemplary embodiment, a polycrystalline body includes aluminum oxide, magnesium oxide, and zirconium oxide, in which the magnesium oxide is present in an amount of between about 250 ppm and 300 ppm. The zirconium oxide is present in an amount of at least 20 ppm and up to about 700 ppm of the weight of the ceramic body.

In another aspect, a method of forming a translucent polycrystalline alumina body includes forming a mixture of ceramic-forming ingredients and an organic binder. The ceramic-forming ingredients include particulate alumina having an average grain size of at least 0.2 μm, for example about 0.4 μm to about 0.6 μm, and additives. The additives, expressed in terms of their oxides in parts per million of the weight of the total ceramic forming ingredients include: magnesium oxide at 350-600 ppm, and zirconium oxide at 20-700 ppm. The method further includes forming a shaped body from the mixture and firing the shaped body to forming a translucent polycrystalline alumina body.

In another aspect, a translucent polycrystalline alumina body includes magnesium oxide and zirconium oxide, these oxides being present in the following amounts, expressed in parts per million of the weight of the ceramic body: magnesium oxide as 250-300 ppm and zirconium oxide as 200-400 ppm.

### BRIEF DESCRIPTION OF THE DRAWINGS

FIG. 1 is a side sectional view of a lamp in accordance with one aspect of the invention.

FIG. 2 is a side sectional view of the discharge tube of FIG. 1.

FIG. 3 is a graph showing initial lumen output of a lamp in accordance with one aspect of the invention.

FIG. 4 is a graph showing total transmission of a lamp in accordance with one aspect of the invention as compared to a convention lamp.

FIG. 5 is a graph showing average grain size of ceramic material in accordance with one aspect of the invention as compared to a conventional ceramic.

FIG. 6 is a graph showing lumen maintenance of a lamp in accordance with one aspect of the invention as compared to a conventional lamp.

FIG. 7 is a graph showing efficacy of a lamp in accordance with one aspect of the invention as compared to a conventional lamp.

FIG. 8 is a graph showing BV maintenance of a lamp in accordance with one aspect of the invention as compared to a conventional lamp.

FIG. 9 is a graph showing delta D of a lamp in accordance with one aspect of the invention as compared to a conventional lamp.

FIGS. 10a-c provide photomicrographs of ceramic samples with varying amounts of MgO content.

### DETAILED DESCRIPTION OF THE INVENTION

Aspects of the exemplary embodiments relate to a ceramic material which includes oxides of magnesium and zirconium, to a ceramic body, such as a discharge vessel, formed of the ceramic material, and to a lamp which includes the ceramic body. While the inventive ceramic composition is exemplified herein with regard to a high pressure sodium discharge lamp, it is understood that the composition may find application to any high intensity discharge (HID) lamp, for example a ceramic metal halide lamp.

The ceramic material disclosed may be used to generate a polycrystalline translucent alumina sintered body, suitable for use as a chamber for high intensity discharge lamps. The material is produced by adding magnesium oxide (MgO) and zirconium oxide (ZrO₂) to alumina powder having a purity of at least 99.8%, e.g. at least 99.9%, e.g. 99.98% by weight. As such, the sintered alumina body includes magnesium oxide as from about 0.025% to 0.03% by weight and zirconium oxide as from about 0.002% to 0.07%, e.g. about 0.002% to 0.05%, e.g. from 0.02% to 0.04% by weight. The resultant sintered alumina is optically translucent and exhibits an average grain size ranging from about 20 microns to about 40 microns. For the monolithic high pressure sodium (HPS) lamps, this alumina doped with MgO and ZrO₂ shows superior resistance to sodium attack during lamp operation, as compared to the same alumina doped with only MgO. As a result, a lamp made of the MgO—ZrO₂ doped alumina in accord herewith exhibits longer life and better lumen maintenance. All percentages and parts per million (ppm) referred to herein are expressed by weight of the doped alumina composition as a whole, except as otherwise noted.

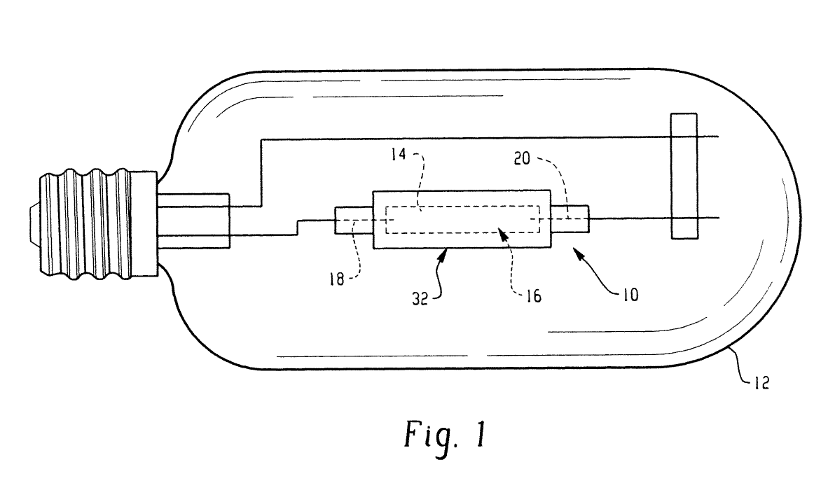

With reference to FIG. 1, an exemplary high pressure sodium lamp is shown, though other lamp configurations will benefit from use of the alumina composition as disclosed herein as well. The lamp of FIG. 1 includes a ceramic discharge vessel in the form of a discharge tube 10, which may be disposed within a transparent outer vitreous envelope 12. Discharge tube 10 defines an inner chamber 14 which contains a fill 16 under pressure that is capable of sustaining an arc discharge when energized.

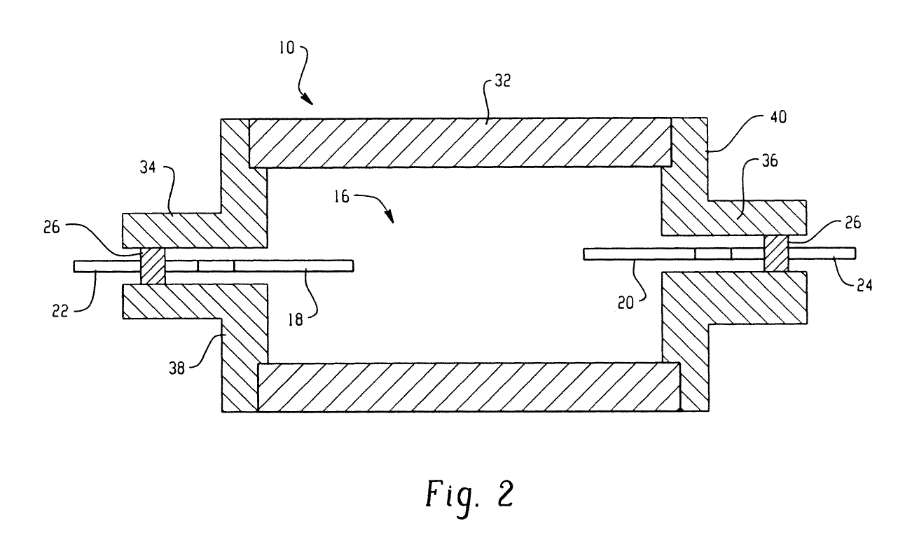

As illustrated in FIG. 2, electrodes 18, 20, formed from tungsten or other suitable electron emissive material, are at least partially disposed within the discharge chamber 14. Electrical lead wires 22, 24, which may be formed, for example, from molybdenum or niobium or other such suitable material, allow coupling of electrical energy to the tungsten electrodes 18, 20 to enable excitation of the fill 16. Sealing frit 26 bonds the lead wires 22, 24 to the alumina of the arc chamber 14 at either end.

The discharge vessel 10 may include a cylindrical body portion 32 with leg portions in the form of tubes 34, 36 extending axially from end caps 38, 40 of the body portion. Other configurations of the body portion are also contemplated, such as a generally spherical or oblate shape. The body portion 32, leg tubes 34, 36, and end caps 38, 40 of the exemplary embodiment may all be formed from a polycrystalline aluminum oxide (alumina, Al₂O₃) ceramic doped with magnesium (Mg) and zirconium (Zr). These elements may be present primarily in the form of their oxides, i.e., as magnesia (MgO) and zirconia (ZrO₂). While the exemplary ceramic composition is described in terms of a discharge vessel, it is to be appreciated that the exemplary ceramic may find other applications.

An exemplary fill 16 for a high pressure sodium lamp includes sodium, mercury, and a starting gas. Exemplary starting gases are inert gases, such as argon, xenon, krypton, and combinations thereof. The inert gas (or gases) in the fill may have a cold fill pressure from about 10 to about 500 torr, e.g., about 200 torr, which increases during lamp operation. The partial pressure of the sodium may range from about 30 to about 1000 torr during operation, e.g., about 70 to 150 torr for high efficacy.

For a ceramic metal halide lamp, the fill may include a mixture of mercury, an inert gas, such as argon, xenon, krypton, and combinations thereof, and a metal halide. Exemplary metal halides are halides (e.g., bromides, iodides) of rare earth elements, such as scandium, indium, dysprosium, neodymium, praseodymium, cerium, thorium, and combinations thereof. However, other fill compositions may be used with the exemplary discharge vessel.

The arc discharge between electrodes 18, 20 may be initiated by a starting voltage in the form of a pulse. The arc discharge is then sustained during lamp operation by the ionized vapor from the lamp fill and the operating voltage.

As is known in the art, the discharge vessel 10 may be formed by sintering together green ceramic components, optionally followed by further processing of the sintered vessel to increase transmittance, as described, for example, in U.S. Pat. Nos. 6,639,362 6,741,033, and 7,063,586. U.S. Pat. Nos. 5,424,609, 5,698,948, and 5,751,111 disclose alternative discharge vessels for which the alumina ceramic disclosed herein may be used.

In particular, the green ceramic components are fabricated by die pressing, extruding, or injection molding a mixture of a ceramic powder and a polymer binder composition. The components are pre-sintered to about 900-1200° C. in air to remove any organic processing aids. The pre-sintered components are tacked, and then partially sintered at a temperature of around 1600-1900° C. in a wet hydrogen atmosphere to form gas-tight joints. During this sintering, the components shrink to different extents. The differential shrinkage is used advantageously in forming the gas-tight joints. The sintered discharge tube may be subjected to further processing to increase transmittance, as noted above.

The green ceramic components used to form the discharge tube may be formed from a particulate mixture which is predominantly particulate aluminum oxide (generally alumina, AlO₃). The alumina particles may be at least 99.8%, e.g. about 99.9% pure alumina, e.g., about 99.98% pure alumina, and have a surface area of about 1.5 to about 50 m²/g, typically about 4 to 10 m²/g. In some embodiments, the average particle size is at least 0.2μ and in some embodiments, the particle size is at least about 0.4μ to 0.6μ, e.g. about 0.5μ.

In accord with an embodiment hereof, small amounts of magnesium oxide (magnesia, MgO) and zirconium oxide (zirconia, ZrO₂) are mixed with the alumina in its green state. In some instances, the magnesia and zirconia may be mechanically mixed with the alumina in the powder form. The powders may have a particle size of from about 0.1μ to about 1.0μ. The powdered magnesia- and zirconia-containing alumina may then be used to form the green ceramic body, for example by a die pressing process.

In the alternative, the alumina powder may be pre-doped with MgO and ZrO2, or the particulate alumina may be doped with an aqueous nitride solution which includes soluble salts of magnesium and zirconium. This doped alumina may be suitable, for example, for use in extrusion or injection molding processing. If used, the magnesium and zirconium salts are converted to their oxides during the pre-sintering stage. In the alternative, the acetate salts of the magnesium and zirconium dopants may be used to generate the desired oxide forms.

The resulting mixture of ceramic-forming ingredients is combined with a liquid binder composition which includes an organic binder, a solvent such as water, and optionally a lubricant. In some embodiments, organic binders, which may be used individually or in combination, include organic polymers such as polyols, polyvinyl alcohol, vinyl acetates, acrylates, cellulosics such as methyl cellulose or cellulose ethers, polyesters, poly acrylamide and stearates, or any other suitable organic polymer of the type listed. In other embodiments, the binder composition may comprise a wax, such as paraffin wax, having a melting point of about 73-80° C. Other suitable binder components may include, for example, beeswax, aluminum stearate, and stearic acid. Suitable lubricants include, for example, oleic acid, or other carbolic acid-based lubricants containing twelve to twenty carbons.

For example, in one embodiment the mixture of ceramic forming ingredients is combined with a water soluble poly acrylamide binder having an average molecular weight of about 20,000 to 500,000, e.g., about 350,000. It is understood that substantially all of the organic binder content will be removed during the pre-sintering and sintering processes. The mixture may be further combined with deionized water as the solvent and oleic acid as a lubricant. For example, a suitable extrusion formulation may include 0.1-1 wt % of poly acrylamide, 0.1-1 wt % of oleic acid, 15-25 wt % of water, and the balance, alumina powder doped with magnesia and zirconia, and other ceramic-forming ingredients.

In one embodiment, the green ceramic may be formed by injection molding or an extrusion process, e.g., screw extrusion or piston extrusion. In the case of injection molding, the mixture of ceramic material and binder composition is heated to form a highly viscous mixture. The mixture is then injected into a suitably shaped mold and cooled to form a molded part. Subsequent to injection molding, the binder is removed from the molded part, typically by thermal treatment, to form a debindered part. The thermal treatment may be conducted by heating the molded part in air or a controlled environment, e.g., a vacuum, nitrogen, or rare gas, to a maximum temperature and holding it at that temperature. For example, in one embodiment the temperature is slowly increased from room temperature, at a rate of about 2-3° C./hour, up to 160° C. At this point, the temperature is increased at a rate of 100° C./hour up to about 900-1200° C., and then holding the maximum temperature for the amount of time needed to remove substantially all of the binder system from the debindered part, e.g. about 1-5 hours. The part is then cooled.

In the case of an extrusion process, such as screw extrusion or piston extrusion, the powdered alumina material may be mixed with the dopants, in the form of nitrides of magnesium and zirconium, i.e. Mg(NO3)2 and ZrO(NO3)2), polyacrylamide binder, and oleic acid lubricant, and then dissolved in water. For example, in one embodiment the doped alumina may be mixed with 0.95 wt % polyacrylamide binder and 0.22 wt % oleic acid lubricant, aong with 23.5 wt % water, the remaining portion of the mixture being the doped alumina. This mixture is then kneaded as dough, for example using Bramley and Ross Mixer, and extruded as a green tube body. The green tube body may then be dried in an atmosphere of heated air, at about 40-50° C., for at least half an hour to remove excess water from the green body. The drying step may be followed by a presintering process and then an optional debindering process.

After drying, the extruded or molded parts may be further heat treated at about 600° C. to remove completely any remaining organics. The debindered parts are then pre-sintered at about 900° C. to about 1200° C., e.g. about 1050° C., in air, to provide the green ceramic with sufficient strength. The pre-sintered green components of the discharge tube prepared in accord with the foregoing may then be adhesively tacked together in the desired configuration for forming the ceramic body by sintering. This sintering step may be carried out by heating the pre-sintered green components, for example under wet hydrogen atmosphere having a dew point of about 10 to 15° C. During sintering the temperature is progressively raised to a maximum temperature of about 1800-1900° C. and held at this temperature for at least about 2 hours, e.g. about 4 hours. Finally, the temperature is gradually reduced to room temperature to avoid thermal shock. The resulting ceramic material comprises densely sintered polycrystalline aluminum doped with magnesium and zirconium oxides. The ceramic body exhibits substantially homogeneous grain growth, which provides for reduced sodium depletion.

In one embodiment, the various ceramic parts may be formed by different processes. For example the cylindrical body portion 32 (see FIG. 2) may be formed by extrusion, while the end caps 26 may be formed by die pressing. The exact compositional make-up of the pre-extrusion or pre-press mixture may not be identical, as per the foregoing disclosure regarding different processing methods. Regardless, both parts may be processed in accord with the foregoing to form a discharge tube having the desired configuration.

In general, the average (mean) grain size of the alumina particles in the sintered ceramic body is at least from 1 μm up to about 200 μm, for example about 10 μm up to about 60 μm, e.g., at least 20 μm, and in some embodiments between about 25 μm and about 45 μm, to provide a discharge vessel with translucent properties while maintaining the strength properties of the ceramic. In one embodiment, less than about 10% of the grains are above 100 μm, for example at least 99.9% of the grains are less than 75 μm in diameter.

In accord with the foregoing, the ceramic-forming components are inorganic oxides or are converted thereto during formation of the parts or during sintering. These are primarily alumina, magnesia, and zirconia compounds in the illustrated embodiment. These ingredients may be present in the pre-sintered composition in the following amounts, in parts per million (ppm), expressed as the oxide, based on the total weight of all oxides of the ceramic-forming ingredients present.

Magnesia: may be present at up to 600 ppm, e.g., greater than 350 ppm; and Zirconia: may be present at up to 700 ppm, e.g., at least about 200 ppm; such as from about 200 ppm to about 400 ppm

Alumina may make up the balance of the ceramic forming ingredients. In one embodiment all other ceramic forming ingredients, i.e., other than alumina, magnesia, and zirconia, or their precursors, are present in the pre-sintered composition at a level at which the resulting sintered body has a total of less than 700 ppm, and in some embodiments no more than 450 ppm of these other ceramic forming ingredients. Such additional additives or impurities may include oxides of K, Ca, Na, Si, Fe, and other like elements. While the total amount of the impurities may be greater than the amount of zirconia or magnesia, the amount of any given additive is significantly less than the amounts of magnesia or zirconia.

The concentration of alumina in the finished ceramic body, expressed as ppm of the total oxides, is generally about the same as that prior to sintering. The concentration of zirconia may be reduced by up to about 50 ppm. In the case of magnesia, however, a portion of the magnesia ranging from about 100 ppm to about 300 ppm may be lost during processing, e.g., by vaporization.

The finished ceramic body may thus include the following oxides, based on the total weight of the ceramic body.
Magnesia: at least 50 ppm, up to 500 ppm. In one specific embodiment, magnesia is present at 250-300 ppm.
Zirconia: at least 100 ppm, e,g., at least 200 ppm. Zirconia may be present at up to 700 ppm, e.g., up to 400 ppm, such as 200-400 ppm.

Expressed as molar ratios, the molar ratio of MgO:ZrO₂ in the sintered body may be from about 1:2 to about 15:1, and in one embodiment, from 2:1 to 5:1. In one embodiment, the ratio is about 3:1.

These oxides are substantially uniformly distributed through the body. The fired ceramic body may be substantially free of oxides of alkali metals and alkaline earth metals, such as oxides of sodium, potassium, and calcium. By “substantially free” it is understood that, for example, these oxides may be present at a total concentration of less than about 150 ppm.

The fired ceramic body is predominantly polycrystalline alumina, for example, at least 95%, e.g. at least 99% alumina, with a hexagonal close-packed structure. The body is translucent rather than transparent, i.e., the amount of diffuse light exceeds the in-line light which is transmitted through the body. For example, about 20% or less of the light is emitted in-line, as compared with about 80% for a transparent body. The magnesia imparts transparency to the finished tube.

As has been shown, progressive sodium loss results in a corresponding continual rise in the lamp operating voltage, a decrease of both correlated color temperature and color rendering index, realized in a color shift from white to pink, wall darkening, and other limitations to useful lamp life. It has been found that magnesia can be advantageous in controlling sodium loss, and is most effective when it is present at relatively low levels. While a certain amount of magnesium oxide is necessary in alumina ceramic to obtain a high degree of translucency by eliminating the porosity and controlling the alumina grain growth, too much magnesium oxide is undesirable because excessive magnesium oxide and its interaction with surrounding alumina form a path for the depletion of sodium from the fill, which causes or participates in each of the foregoing negative effects on the lamp.

The alumina ceramic composition disclosed herein, however, provides a more ideal alumina ceramic for lamp chamber applications. The sintered alumina contains only that amount of magnesium oxide and zirconium oxide necessary to the successful elimination of pores and to obtaining enough ceramic density, transmission, and homogeneous grain size distribution to optimize lamp performance, while minimizing sodium depletion and its associated problems, i.e. increased operating voltage, reduced lumen output, wall darkening, and shorter lamp life. It further provides a suitable alumina ceramic for use in lamps that allows for high efficiency and reduced power consumption.

Known monolithic HPS lamps made of MgO-only doped alumina show a large amount of sodium leaking out of the alumina chamber and reacting with the alumina chamber to foini aluminum, which is then deposited at the surface of the outer jacket, causing darkening of the jacket and consequently reduced lamp emission, i.e., shortening lamp life. In contrast, the sintered alumina in accord with at least one embodiment of the invention, for example for use in the same type of monolithic HPS lamps, has a reduced amount of magnesia in the ceramic alumina, reducing the amount thereof in the spinel phase. The sintered alumina also contains zirconia. This new sintered alumina, e.g., MgO—ZrO₂ doped alumina ceramic, provides better sodium attack resistance, especially for monolithic HPS lamps, as well as reduced sodium leakage from the discharge tube. Ceramic lamps fabricated with the ceramic discharge tubes described herein thus have a longer useful life. Without intending to be bound by any specific theory, zirconia is believed to increase the solubility of magnesia in the alumina lattice, reducing the amount of magnesia available to form the spinel phase with the alumina, and instead incorporating free magnesia at the alumina grain boundary which reduces the available path for sodium attack.

Without intending to limit the scope of the invention, the following examples demonstrate exemplary compositions.

### EXAMPLES

Ultra high purity alumina powder (99.98% alumina) was doped with an aqueous solution containing magnesia as 0.042 wt % and zirconia as 0.040 wt % to form a PCA body in accord with an embodiment of the invention, Sample A. A control sample including the same high purity alumina powder but with only 0.063 wt % magnesia and no zirconia was similarly formed, Sample B. The doped mixtures included a polymer binder containing of cellulose ether and oleic acid lubricant. Both samples were extruded to form green ceramic tubes using a piston extruder. The compositions of the unsintered tubes were as follows (the balance in each case being the ultra high purity alumina, e.g. 99.9% pure alumina):
Sample A: 420 ppm MgO, 400 ppm ZrO₂
Sample B: 630 ppm MgO

The discharge tubes were sintered at 1840° C. in a wet hydrogen atmosphere. The tubes had a wall thickness of about 0.75 mm. On firing, the magnesia content had dropped as indicated below. The compositions of the sintered tubes were as follows (the balance in each case being the ultra high purity alumina:
Sample A: 280 ppm MgO, 370 ppm ZrO₂
Sample B: 430 ppm MgO

The ceramic materials prepared in accord with the foregoing were used to create samples of each of compositions A and B above. The samples were subject to 400 W accelerated aging lamp testing. All testing was done in an identical manner for both types of sample ceramic. The data provided in each case provides a mean value for the parameter tested from the total number of tests performed (the field).

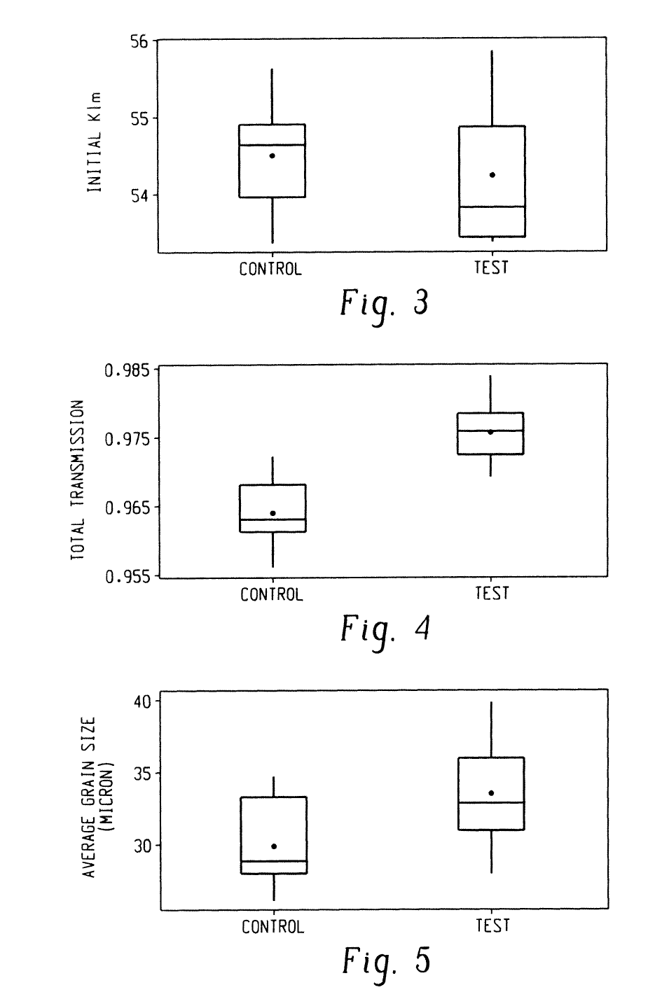

Initial Lumen Output. This test involved measuring the initial lumen output for each type of sample over the entire field. As can be seen in FIG. 3, the control samples had a mean lumen output of about 54.5 Klm. The sample in accord with the invention exhibited a comparable mean lumen output of about 54.3 Klm. Therefore, use of the combination of magnesia and zirconia as dopants for ultra pure alumina in accord herewith does not affect the initial lumen output of lamps formed from the material as compared to more conventional lamp materials.

Total Transmission. In this test, the total transmission of the ceramic test samples A and B was determined FIG. 4 shows the total transmission of the control samples (B) to have a mean value of about 0.965. In contrast, the total transmission of the ceramic samples in accord with the invention (A) exhibited a mean value of about 0.976. Based on the foregoing, it is concluded that transmission of ceramic materials doped with magnesia and zirconia in accord herewith is improved, as compared to conventional MgO-only doped alumina.

Average Grain Size. The average grain size in the ceramic materials constituting A and B in accord with the foregoing were evaluated and measured. While the control material samples (B) exhibited a mean average grain size of about 30 microns, the inventive material samples (A) had a mean average grain size of about 34 microns. This is shown in FIG. 5. This increase in average grain size of the material contributes to a reduction in sodium attack, and in degradation of lamp performance.

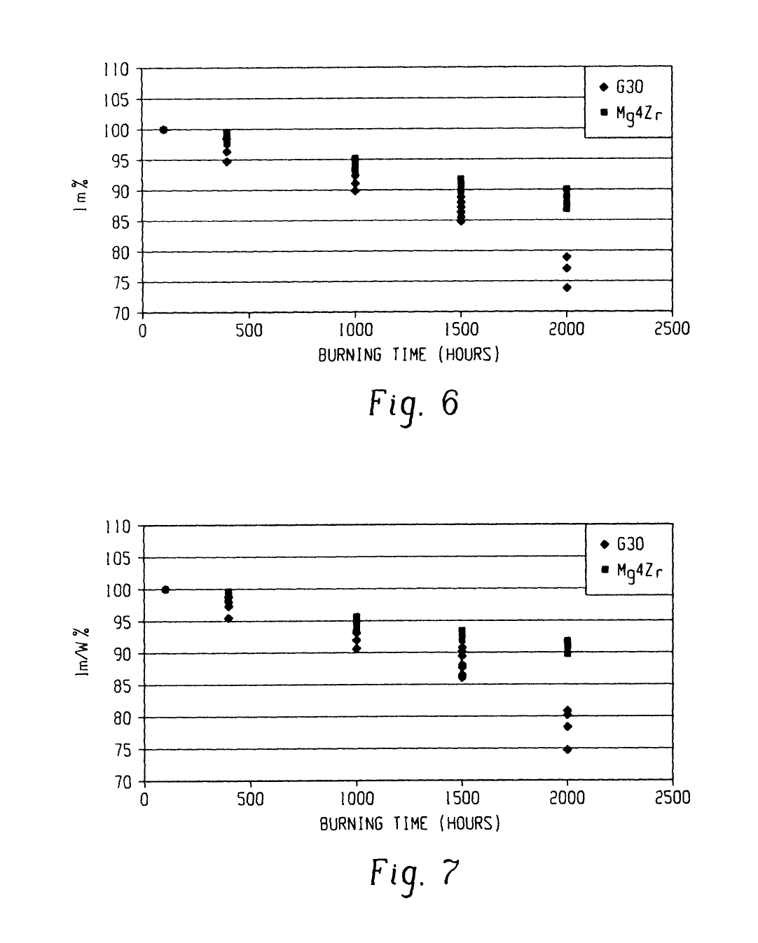

Lumen Maintenance. The samples were also evaluated for lumen maintenance which is a parameter that suffers negatively due to sodium loss. The testing provided data at various times over an accelerated 2000 hour burn cycle. As FIG. 6 shows, the lamps created from the MgO—ZrO₂ doped alumina dropped from 100% at burn initiation (0 hours) to about 84%, or only a 16% lumen maintenance loss. However, the MgO-only doped alumina exhibited a drop in lumen maintenance of about 26%, down to about 74%, over the 2000 hour accelerated burn test.

Lamp Efficacy. FIG. 7 sets forth a comparison of lamp efficacy in lumens/watt % over the accelerated 2000 hour burn test. Lamps formed with the samples A containing magnesia and zirconia performed well under the accelerated aging conditions, while the samples formed with magnesia alone (B) showed a significant drop in lamp efficacy. Additionally, the magnesia alone samples showed a much higher variability in results than the MgO—ZrO₂ lamps.

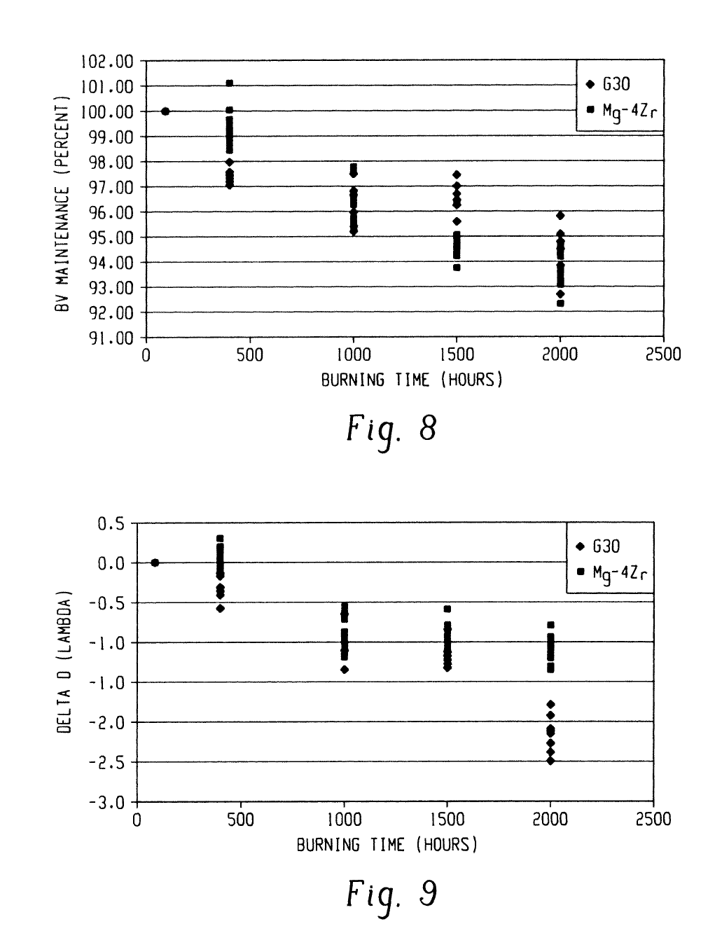

Burning Voltage (BV) Maintenance. The BV maintenance of each type of sample was also tested over the 2000 hour accelerated burn test period. As shown by the data set forth in FIG. 8, both types of sample, A and B, exhibited comparable BV maintenance, supporting a conclusion that the ceramic doped in accord herewith performs comparably and is not negatively affected by the inclusion of a reduced amount of MgO in conjunction with ZrO₂.

Delta D. This particular test provides data with regard to delta D, a performance parameter for which sodium loss can have a critical affect, resulting in reduced lamp performance and life. FIG. 9 sets forth data proving that the MgO—ZrO₂ doped alumina shows less variation in delta D over the 2000 hour accelerated burn test, i.e. the sodium loss is negligible given that no negative affect is seen on this performance parameter. This is critical with regard to Na-loss because as the delta falls sodium attack becomes more prevalent.

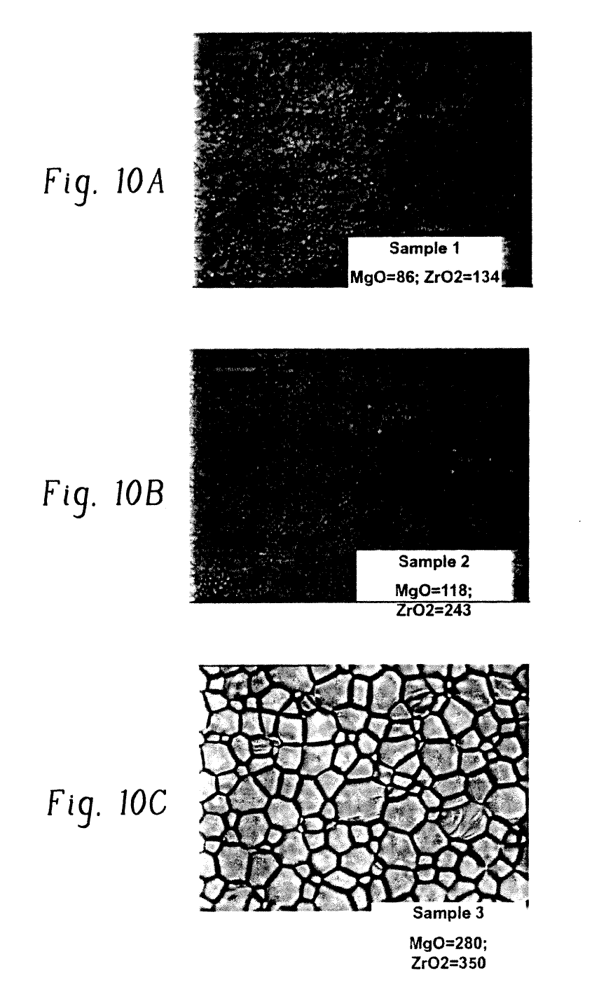

Grain Morphology. The photomicrographs set forth as FIGS. 10a-c show a difference in grain morphology in samples, prepared in accord with that presented hereinabove, all created from high purity alumina doped with MgO and ZrO₂, but at varying levels. FIG. 10a corresponds to a sample having 86 ppm magnesia and 134 ppm zirconia. FIG. 10b corresponds to a sample having 118 ppm MgO and 243 ppm ZrO₂. FIG. 10c corresponds to 280 ppm MgO and 350 ppm ZrO₂. The samples having lower amounts of MgO, (a) and (b), exhibited inhomogeneous grain growth. Sample (c), however, having an increased amount of MgO, exhibited a much more desirable grain growth. This latter sample (c) corresponds to the MgO—ZrO₂ content in accord with an embodiment of the invention, i.e 250-300 ppm MgO and 200-400 ppm ZrO₂. This example demonstrates the importance of having enough MgO but not too much, i.e. within the stated ranges.

The invention has been described with reference to the preferred embodiments. Obviously, modifications and alterations will occur to others upon reading and understanding the preceding detailed description. It is intended that the invention be construed as including all such modifications and alterations.

1. A polycrystalline body comprising translucent, sintered magnesium oxide/zirconium oxide-doped alumina, in which at least 99.9% of the alumina grains of the body have a diameter of less than 75 μm, and wherein the molar ratio of MgO:ZrO₂ in the body is 1:2 to about 15:1.

2. The polycrystalline body of claim 1, wherein the oxides are present, expressed in parts per million of the weight of the ceramic body as follows:
magnesium oxide at least 250 ppm; and
zirconium oxide at least 20 ppm.

3. The polycrystalline body of claim 1, wherein the magnesium oxide is present as no more than 300 ppm.

4. The polycryustalline body of claim 1, wherein the zirconium oxide is present as up to 700 ppm.

5. The polycrystalline body of claim 1 wherein the molar ratio of MgO:ZrO₂ in the body is 2:1 to about 5:1.

6. The polycrystalline body of claim 1, wherein the body contains less than 150 ppm total of oxides of alkali metals and alkaline earth metals.

7. The polycrystalline body of claim 1, wherein a green body from which the polycrystalline body is prepared includes oxides of magnesium and zirconium, expressed in parts per million of the weight of the ceramic body as follows:
magnesium oxide up to about 600 ppm; and
zirconium oxide up to about 700 ppm.

8. A high pressure sodium lamp comprising a sealed discharge tube including a sintered polycrystalline alumina body doped with MgO and ZrO₂, wherein the sintered polycrystalline alumina body exhibits an average grain size of at least about 20 μm to about 40 μm, a molar ratio of MgO:ZrO₂ in the body of 1:2 to about 15:1, and wherein the sealed discharge tube contains a fill comprising sodium and mercury.

9. The lamp of claim 8, wherein the lamp exhibits lumen maintenance of 84% after 2000 hours bum, while the same lamp but without any zirconium oxide exhibits lumen maintenance of 74% after 2000 hours burn.

10. The lamp of claim 8, wherein the lamp exhibits a delta D of about 1.7 as compared to the same lamp but without zirconium oxide and that exhibits an increased delta D of about 2.5.

11. The lamp of claim 8, wherein the sintered polycrystalline body is substantially free of oxides of alkali metals and alkaline earth metals.

12. The lamp of claim 8, wherein the body is translucent.

13. The lamp of claim 8, wherein the fill further includes a starting gas.

14. The lamp of claim 8, further including electrodes extending into the chamber.

15. The lamp of claim 8, further comprising a vitreous envelope which surrounds the discharge vessel.

16. A method of forming a translucent polycrystalline alumina body comprising: forming a mixture of ceramic-forming ingredients and an organic binder, the ceramic-forming ingredients including particulate alumina having an average grain size of at least 0.2 μm and additives, the additives being expressed in terms of their oxides in parts per million of a weight of the total ceramic forming ingredients as follows:
magnesium oxide 350-600 ppm; and
zirconium oxide 20-700 ppm;
forming a shaped body from the mixture;
firing the shaped body to form a translucent polycrystalline alumina body doped with MgO and ZrO₂.

17. The method of claim 16, wherein the magnesium oxide in the translucent polycrystalline alumina body is no more than 300 ppm.

18. The method of claim 16, wherein zirconium oxide is no more than 400 ppm.

19. The method of claim 16, wherein the mixture is substantially free of alkali metals and alkaline earth metals and compounds thereof.

20. The method of claim 16, wherein the additives include salts of magnesium and zirconium.

21. The method of claim 16, wherein the forming a shaped body from the mixture comprises at least one of die pressing or extruding.

22. A method of forming a discharge tube comprising:
forming a ceramic body according to the method of claim 16, and
sealing a fill in a chamber of the ceramic body, the fill including sodium and optionally at least one of mercury and a starting gas.

23. The method of claim 20, further including positioning electrodes so as to extend into the chamber.
